(19) United States
(12) Patent Application Publication
(10) Pub. No.: US 2004/0143568 A1
(43) Pub. Date: Jul. 22, 2004

(54) Search method implemented with a search system

(76) Inventors: Kuo-Jen Chao, Yung-Kang City (TW); Tu-Hsin Tsai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/461,469

(22) Filed: Jun. 16, 2003

(30) Foreign Application Priority Data
Jan. 20, 2003 (TW) 092101070

(51) Int. Cl. G06F 7/00

(52) U.S. Cl. 707/3

(57) ABSTRACT

A search method implemented with a search system. The search system includes a plurality of data files, a standard code index file, a converter, and a simplified code index file. The method includes using the converter to convert standard codes in the standard code index file to simplified codes, storing the simplified codes into the simplified code index file, using a search interface to input simplified codes of data to be searched, and using a search engine to search the simplified code index file according to the input simplified codes.

### CROSS REFERENCE TO RELATED APPLICATIONS

### BACKGROUND OF INVENTION

1. Field of the Invention

The present invention relates to a search method, and more specifically, to a search method implemented with a simplified code search system.

2. Description of the Prior Art

As the wireless telecommunication generation approaches, it is increasingly common to access the Internet with mobile phones. Although searching for data on the Internet from a PC is now a simple thing, so far it is not easy to do with a mobile phone. The reason is that there are only 10 numeral keys and several function keys on a mobile phone keypad. If we use a tiny input device, such as a mobile phone keypad, even more advanced input methods are not straightforward.

Please refer to FIG. 1. FIG. 1 is a schematic diagram of a prior art search system 10. The prior art search system 10 comprises a database 12 including a plurality of data files 14, and a standard code index file 16. The data of the database 12 are stored in the plurality of data files 14 in standard code format. The method for searching the data is described as follows. First, the data files 14 of the database 12 that might be requested by a user are selected. Then, a standard code index is constructed from the data files 14 and is stored in the standard code index file 16. A user inputs the data to be searched through an input unit of a search interface that could be a keyboard and a display of a computer, or a mobile phone 22 capable of providing network service shown in FIG. 1. The data to be searched that is inputted by the user is transmitted to a search engine 20 through a network, and is converted to the standard code format by a converter 18. After that, according to the standard code of the data to be searched, the search engine 20 starts to search the standard code index file 16 by a step-by-step search or a fulltext search. Thereafter, a search result is ranked according to the quantity of the data to be searched appearing in each data file 14, or according to the frequency of the data to be searched. Finally, the search result is displayed on a display device of the search interface such as a display panel 26 of the mobile phone 22 shown in FIG. 1. When utilizing the prior art search system 10, the user can select a familiar input method to quickly input keywords if the search interface is a keyboard of a computer. However, if the search interface is a mobile phone keypad 24, it takes a lot of time for the user to input keywords since the keys are relatively few.

Furthermore, a computer contains a great deal of memory, so lots of common vocabulary databases are built in the computer for each input method. As the user inputs a homophone (for example, in English “to”, “too”, or “two”), the input method can revise the homophone according to common vocabulary entries in the built-in common vocabulary databases. Referring to the Chinese character/phrase list of FIG. 6, for example, when the user inputs a Chinese character 60 by using the mandarin Chinese phonetic input method, a different Chinese character 62, being a homophone, might appear on the display. However, once the user inputs a following Chinese character 64, a Chinese phrase 66 will be revised to a phrase 68 according to the built-in common vocabulary databases. It is more convenient for the user to use the built-in common vocabulary databases to revise homophones. The user does not need to select specific characters all the time, which improves the inputting efficiency. However, since there are numerous homophones in the Chinese language, the built-in common vocabulary databases occupy quite large memory spaces, which is not suitable for pocket electronic products such as the mobile phone 22.

Please refer to FIG. 2. FIG. 2 is a schematic diagram of a mobile phone keypad 24 having mandarin phonetic symbols. The prior art input method applied to the mobile phone maps several symbols to one numeral key on the keypad 24. The user presses the numeral key repeatedly to select a desired symbol. Referring to FIG. 6, take the mandarin phonetic input method for example, mandarin phonetic symbols 80, 82, 84 and 86 are mapped to the numeral key “1”, while mandarin phonetic symbols 88, 90, 92 and 94 are mapped to the numeral key “7” and the tones (Mandarin Chinese has several tones for its syllables) are selected by pressing the key “#” as shown in FIG. 2. Accordingly, when the Chinese character 60 is inputted, the user has to press the key “1” four times to input the mandarin phonetic symbol 86, then press the key “7” one time to input the mandarin phonetic symbol 88, and then press the key “#” three times to designate the third tone. Finally, the user has to select the Chinese character 60 from a list of its homophones. Therefore, this prior art input method requires much time.

### SUMMARY OF INVENTION

It is therefore a primary objective of the claimed invention to provide a search method implemented with a simplified code search system for solving the above-mentioned problems.

According to the claimed invention, a search method implemented with a simplified code search system is provided. The simplified code search system comprises a plurality of data files, a standard code index file for storing a standard code index constructed from the plurality of data files, a converter for converting the standard code to a simplified code format, and a simplified code index file for storing simplified code output from the converter. The method comprises converting the standard code in the standard code index file to the simplified code format with the converter, storing the simplified code output from the converter in the simplified code index file, inputting simplified code search data with a search interface, and searching the simplified code index file with a search engine according to the inputted simplified code search data.

These and other objectives of the claimed invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic diagram of a prior art search system.

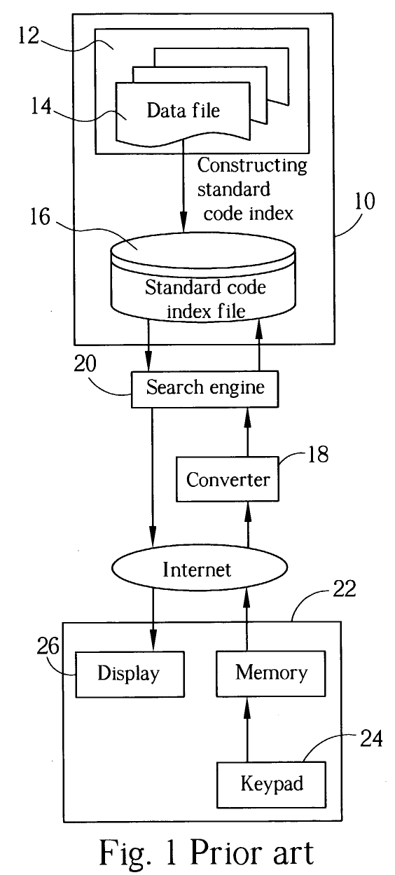

FIG. 2 is a schematic diagram of a mobile phone keypad having mandarin phonetic symbols.

FIG. 3 is a schematic diagram of a simplified code search system of the present invention.

FIG. 4 is a schematic diagram of data shown on a display.

FIG. 5 is a flowchart of the search method of the present invention.

FIG. 6 is a table of Chinese characters and Mandarin phonetic symbols.

### DETAILED DESCRIPTION

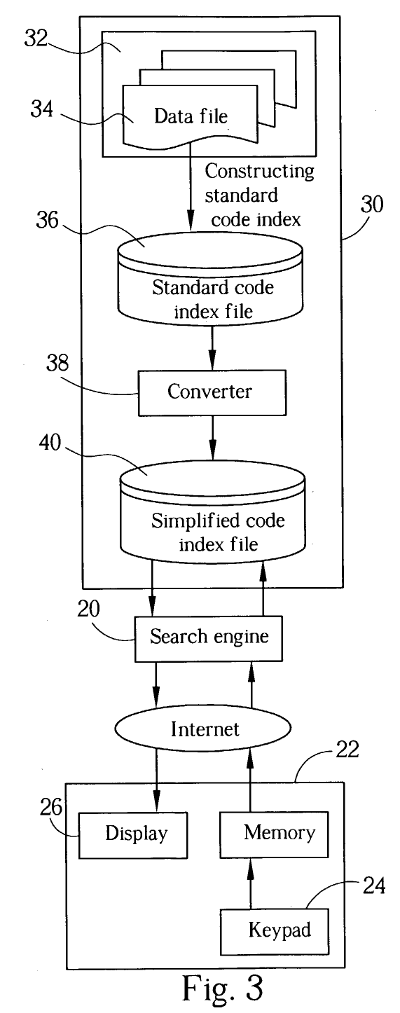

Please refer to FIG. 3. FIG. 3 is a schematic diagram of a simplified code search system 30 of the present invention. The simplified code search system 30 comprises a databank 32, a standard code index file 36, a converter 38, a simplified code index file 40, wherein the databank 32 further comprises a plurality of data files 34. Generally speaking, the data of the databank 32 are stored in the plurality of data files 34 in standard code format. When using the simplified code search system 30, first, the standard code index of the data files 34 is constructed and stored in the standard code index file 36. Then, the standard code stored in the standard code index file 36 will be converted to simplified code format by the converter 38, and stored in the simplified code index file 40. As shown in FIG. 3, when the user inputs the data to be searched in simplified code through a search interface, such as a mobile phone 22. First, the data are inputted through the keypad 24 and transmitted to the search engine 20. Then the search engine 20 will search the simplified code index file 40 according to the simplified code inputted by the user, and transmit the search result to the display 26 of the mobile phone 22 through Internet.

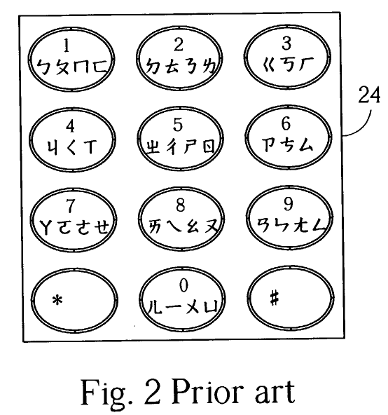

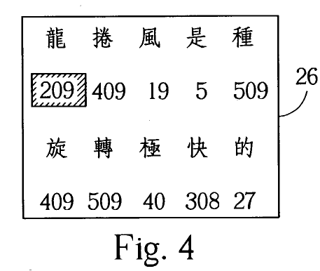

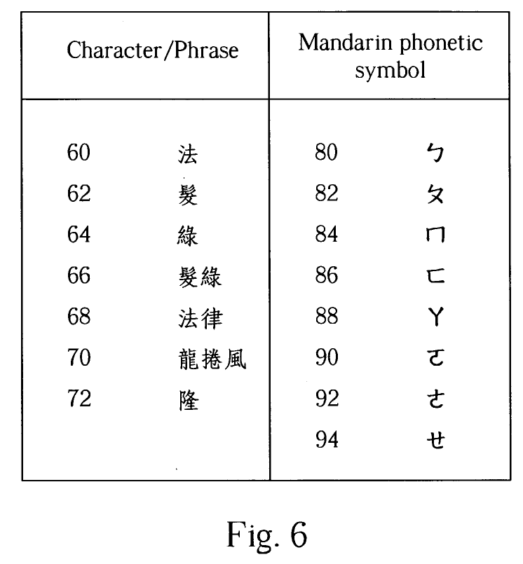

Please refer to FIG. 4. FIG. 4 is a schematic diagram of data displayed on the display 26 shown in FIG. 3. If the user designates the data files 34 of the databank 32 as search ranges, the simplified code search system 30 will construct the standard code index of the data files 34, and store the standard code index in the standard code index file 36. Then the converter 38 will convert the standard code index file 36 to simplified code format, and store the simplified code in the simplified code index file 40. The user can select to display the data files 34 as well as its simplified code on the display 26. The simplified code could be the code of any input methods, such as the code of mandarin phonetic input method shown in FIG. 4. Referring to FIG. 6, if the keywords to be searched in the data files 34 is phrase 70, first, the user has to determine the simplified code of the first Chinese character of the phrase 70, by referring to the mobile phone keypad 24 shown in FIG. 2, such that the simplified code “209” that represents the first Chinese character of the phrase 70 is inputted. Then, the search engine will search the simplified code “209” in the simplified code index file 40, and display the Chinese character corresponding to the simplified code “209” on the display 26. If the first data of the simplified code index file 40 is the phrase 70, the user can input the remaining two simplified codes “409” and “19” that represent the next two Chinese characters as displayed on the display 26. If the Chinese character corresponding to the simplified code “209” in the simplified code index file 34 is instead character 72 of FIG. 6, a homophone of the first character of the phrase 70, then the user has to input the simplified code “409” that represents the second Chinese character of the phrase 70 by referring to the mobile phone keypad 24 shown in FIG. 2. At this time the search engine 20 will search in the simplified code index file 40 according to the simplified code “209409”, and display the search result on the display 26. If the Chinese characters corresponding to the simplified code “209409” are not the first two characters of the phrase 70, the user has to input the simplified code “19” that represents the third Chinese character by referring to the mobile phone keypad 24, then the search engine will search the simplified code index file 40 according to the simplified code “20940919”, and display the search result on the display 26. It is worth mentioning that the search result can be arranged according to the search frequency of the data in the data file 34, or according to the number of the data appearing in the data file 34.

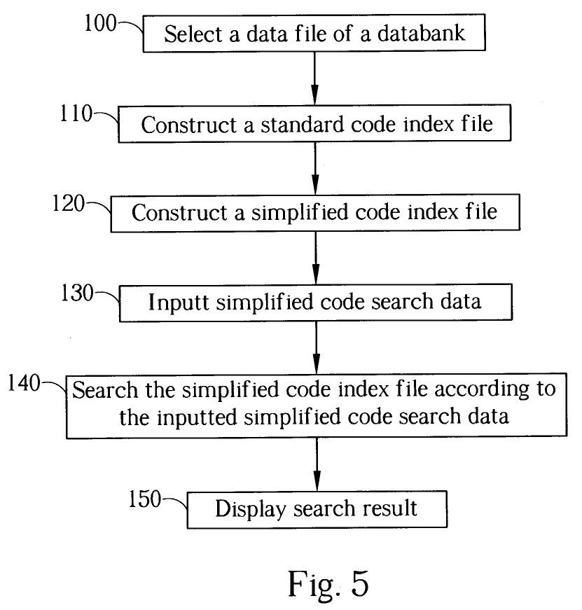

Please refer to FIG. 5. FIG. 5 is a flowchart of the search method of the present invention. The procedures are described as follows:

Step 100: Select a data file of a databank as search ranges;

Step 110: Construct a standard code index of the data file, and store the standard code index in a standard code index file;

Step 120: Convert the standard code in the standard code index file to simplified code format with the converter, and store the simplified code output from the converter in the simplified code index file;

Step 130: Input simplified code search data with a mobile phone keypad;

Step 140: Search the simplified code index file with a search engine according to the inputted simplified code search data, and display the first search result and its simplified code on the display; and

Step 150: Display the final search result on the display.

According to the above-mentioned embodiment, the simplified search system 30 of the present invention converts the standard code stored in the standard code index file 36 to the simplified code with a converter 38, and stores the simplified code output from the converter 38 in the simplified code index file 40. The simplified code format is identical to the simplified code format that the user inputs, so the search engine 20 can search the simplified code index file 40 directly according to the simplified code inputted by the user. As mentioned in the preceding paragraph, when the user wants to search the keyword phrase 70 in the data file 34, all he needs to do is input the simplified code “20940919”. Moreover, after inputting the simplified code “209”, the Chinese characters corresponding to the simplified code “209” will be displayed. If the displayed Chinese characters happen to be the phrase 70, the user can input the entire simplified code “20940919” displayed on the display 26 without referring to the mobile phone keypad 24 shown in FIG. 2. Therefore it is not only convenient to search data by using the simplified code search system 30, but the inputting speed is increased no matter input methods are applied. The above-mentioned embodiment can be applied not only to mobile phones 22, but also to PDAs or other search interfaces.

In contrast to the prior art, the simplified code search system 30 of the present invention converts the standard code stored in the standard code index file 36 to the simplified code with a converter 38, and stores the simplified code output from the converter 38 in the simplified code index file 40. The simplified code format is identical to the simplified code format that the user inputs, so the search engine 20 can search the simplified code index file 40 directly according to the simplified code input by the user. Whereas the prior art search system 10 converts the simplified code inputted by the user to a standard code with a converter 18, and the search engine 20 searches the standard code index file 16 according to the standard code. In this case inputting data and searching data cannot be done simultaneously. However, when using the simplified code search system 30, the user can input the data to be searched, and search data simultaneously.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A search method implemented with a simplified code search system comprising:
a plurality of data files;
a standard code index file for storing a standard code index constructed from the plurality of data files;
a converter for converting standard code to a simplified code format; and
a simplified code index file for storing simplified code output from the converter;
the method comprising:
converting the standard code in the standard code index file to the simplified code format with the converter;
storing the simplified code output from the converter in the simplified code index file;
inputting simplified code search data with a search interface; and
searching the simplified code index file with a search engine according to the inputted simplified code search data.

2. The method of claim 1 wherein the plurality of data files is a web page on the Internet, and the standard code index file and the simplified code index file are stored on a host computer connected to the Internet.

3. The method of claim 1 wherein the search interface is a mobile phone system.

4. The method of claim 2 wherein the search interface has a display device for displaying data; the method further comprising displaying the web page found by the search engine on the display device.

5. The method of claim 2 wherein the search engine is capable of arranging web pages according to a search frequency.

6. The method of claim 2 wherein the search engine is capable of arranging web pages according to the number of simplified codes of the search data from the search interface appearing in the web pages.

7. The method of claim 1 wherein the plurality of data files is stored in a databank.

8. The method of claim 1 further comprising simultaneously displaying the data file and the simplified code search data with the search interface.
